(19) United States
(12) Patent Application Publication
(10) Pub. No.: US 2015/0015213 A1
(43) Pub. Date: Jan. 15, 2015

(54) FREQUENCY RESPONSIVE CHARGING SYSTEM AND METHOD

(71) Applicant: AeroVironment, Inc., Monrovia, CA (US)

(72) Inventors: Alexander Nelson Brooks, Pasadena, CA (US); Scott Garret Berman, Los Angeles, CA (US); Nicholas Hammervold, Torrance, CA (US)

(73) Assignee: AEROVIRONMENT, INC., Monrovia, CA (US)

(21) Appl. No.: 14/389,355

(22) PCT Filed: Mar. 28, 2013
(86) PCT No.: PCT/US13/34469

§ 371 Date: Sep. 29, 2014

Related U.S. Application Data
(60) Provisional application No. 61/617,039, filed on Mar. 28, 2012.

(51) Int. Cl. B60L 11/18

(52) U.S. Cl. CPC B60L 11/1844; B60L 11/1816; B60L 11/1811; B60L 2210/30
USPC 320/137

(57) ABSTRACT

In some embodiments, the present invention includes the use of one or more electric power supply system, or systems, and the electric vehicle, or vehicles, connected thereto, to provide load-based utility grid frequency regulation by varying the amount of power drawn by the vehicle or vehicles.

### CROSS REFERENCE TO RELATED APPLICATION

This application claims to the benefit of U.S. Provisional Patent Applications Ser. No. 61/617,039, filed Mar. 28, 2012, by Brooks et al., which is herein incorporated by reference in its entirety.

### BACKGROUND OF THE INVENTION

Utility grids require that the power generation and loads are in balance in order to keep the frequency constant. When there is an imbalance between the generation and load, the grid frequency will change. Grid frequency regulation can be performed by powerplants varying their generation output up and down from a nominal value. However, powerplants respond relatively slowly to regulation commands and thus correcting the grid frequency in this manner is also very slow.

### BRIEF DESCRIPTION OF THE DRAWINGS

FIGS. 1A-B show an EVSE connected to an electric vehicle and to the utility grid in accordance with at least one embodiment of the present invention.

FIGS. 2A-B show block diagrams of electric vehicle supply equipment in accordance with at least one embodiment of the present invention.

FIGS. 3A-C are graphs showing, in accordance with at least one embodiment of the present invention, sensed grid frequency, calculated rate of change of frequency, vehicle commanded current either in proportion to frequency error or rate of change of frequency, as well as the minimum and maximum charging current values.

FIGS. 4A and 4B is a view of graphs showing, in accordance with at least one embodiment of the present invention, example vehicle responses.

FIG. 4C is a graph of an example vehicle response showing vehicle charging power versus sensed grid frequency.

FIG. 5 is a graph of frequency to time showing a frequency excursion due to a grid fault.

FIGS. 6A and B are graphs showing, in accordance with at least one embodiment of the present invention, load drop on sensed grid fault.

FIG. 7 is a flow chart of a method in accordance with at least one embodiment of the present invention.

FIG. 8 is a flow chart of a method in accordance with at least one embodiment of the present invention.

FIG. 9 is a graphs showing the EVSE max current available and the vehicle charger current draw in accordance with at least one embodiment of the present invention

FIG. 10 shows definitions of charge current values in accordance with at least one embodiment of the present invention.

FIGS. 11A and 11B show autocalibration at start and autocalibration during charging in accordance with at least one embodiment of the present invention.

FIG. 12 shows examples of cases for charging in accordance with at least one embodiment of the present invention.

### DETAILED DESCRIPTION

With utility power grids when an imbalance exists between the power generation and the load the rate of change of frequency is proportional to the amount of the imbalance. Rotating generators tied to the grid have inertia which determines the rate of change of frequency for a given imbalance of generation and load. The more inertia of the generators, the slower the rate of change of frequency will be will be for a given imbalance of power.

Grid operators may run control loops to seek to regulate the grid frequency. These loops use as input the difference between the instantaneous grid frequency and the target frequency (usually 60 Hz in the US). These control loops are implemented with a grid ancillary service called frequency regulation (or often just: regulation). Regulation ancillary services allow the grid operator to directly control the power output or load of resources on the grid that have contracted to provide this service.

Typically regulation commands are sent out every four seconds. Regulation has historically been performed by powerplants by varying their generation output up and down from a nominal value. Variable loads and storage systems can also provide regulation services—loads by varying the amount of power drawn, and storage by varying the amount of power taken from the grid or put back into the grid.

Powerplants respond relatively slowly to regulation commands. Loads and storage have the potential to respond much faster, increasing their relative value. Recent policy changes in the US have mandated ‘pay for performance’ tariffs that reward faster and more accurate response.

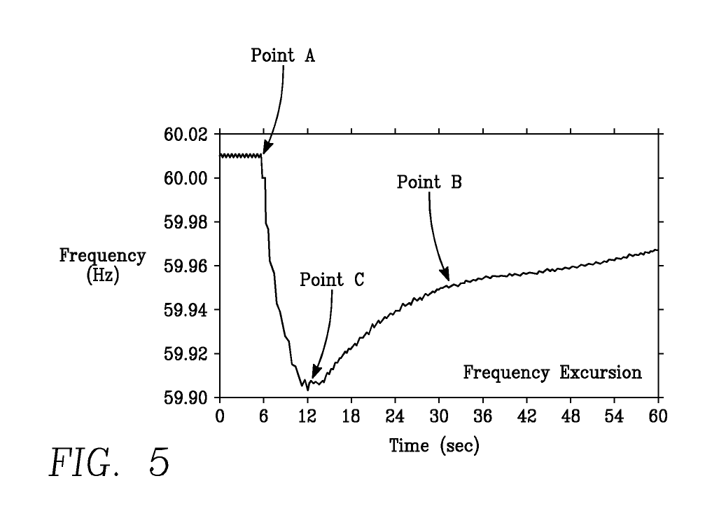

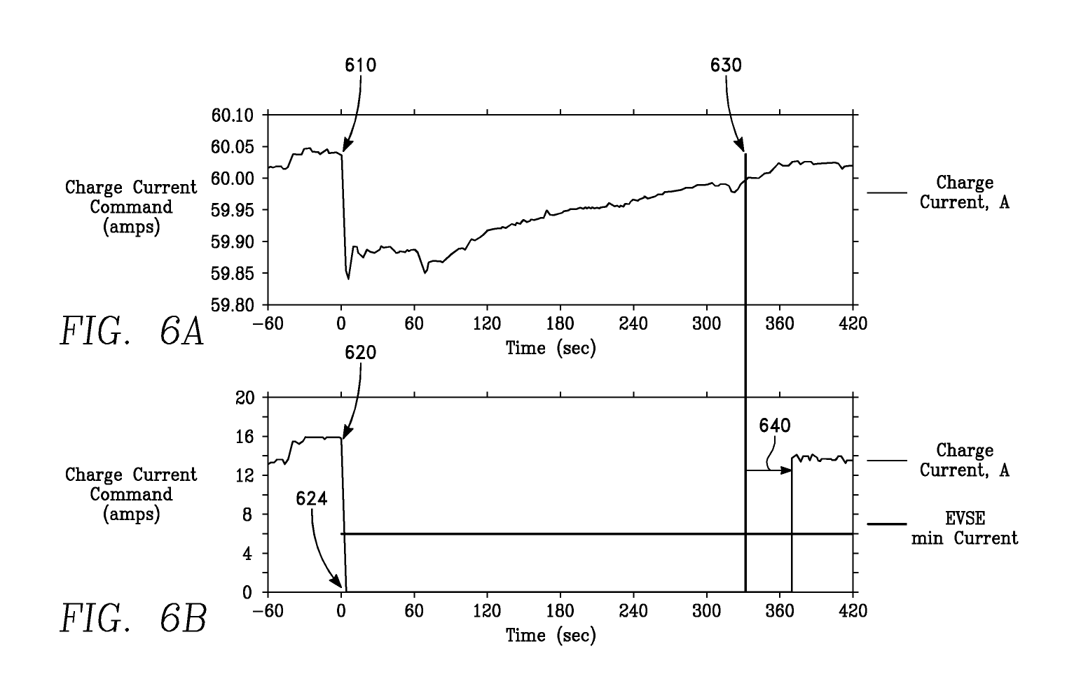

There are occasional fault events on a power grid such as a large powerplant tripping offline that result in a step change in the power generation on the grid. This results in a large instantaneous generation vs. load imbalance that in turn causes a very rapid drop in grid frequency, examples are shown in FIGS. 5 and 6.

Traditional regulation ancillary services are too slow or have too much lag to have an impact in the first several seconds of one of these events. These events need immediate large reductions of load and/or increases in generation in order to minimize the size of the frequency transient. This has been accomplished through having loads be automatically shut off when such a frequency transient is locally detected, as well as by powerplants that have governors that increase or decrease power generation in proportion to the error in the frequency from the target frequency (e.g. 60 Hz).

A metric for the effectiveness of these short-term fault mitigation measures is the grid frequency response characteristic: the ratio of the power deficit on the original grid fault to the maximum error in the grid frequency (usually in units of tenths of a Hz). Example: 200 MW/0.1 Hz.

Powerplant governor response is usually programmed to include a frequency error deadband where no change to the generation is commanded. This deadband, while apparently small (typically 0.01 to 0.02 Hz) may be causing a reduced quality of response in normal and fault situations.

Loads that can vary their power draw smoothly between upper and lower limits in response to locally-sensed grid frequency have the potential to provide a grid service of very high quality. Because of its fast response, such a service can perform two existing services at the same time: (1) short term response to grid faults (what is usually called frequency response, which needs to act faster than current regulation services that are updated at 4 second intervals), and (2) traditional regulation services. Loads can also supplement or entirely replace generator governor frequency response with a higher quality of response that acts very fast and does not have any deadband that degrades the system performance.

### Frequency Responsive Charging

In embodiments the present invention includes the use of one or more electric power supply system, or systems, and the electric vehicle, or vehicles, connected thereto, to provide load-based utility grid frequency regulation by varying the amount of power drawn by the vehicle or vehicles. Such electric power supply systems can be electric vehicle supply equipment (EVSE), which are off-board the vehicle with contactors or relays that can turn on power to the cable that connects to the electric vehicle (EV) to charge its battery. An EVSE, such as those that conform to the Society of Automotive Engineer (SAE) J1772™ standard, may be configured to communicate the available charging current to the vehicle over a pulse-width-modulated pilot signal, where the pilot pulse width is related in a unique way to the available charging current. Other embodiments could include communicating the available charging current digitally, such as over a power line carrier standard like Homeplug Green PHY (http://www.homeplug.org/tech/homeplug_gp). An EVSE may also act to perform some safety functions as well.

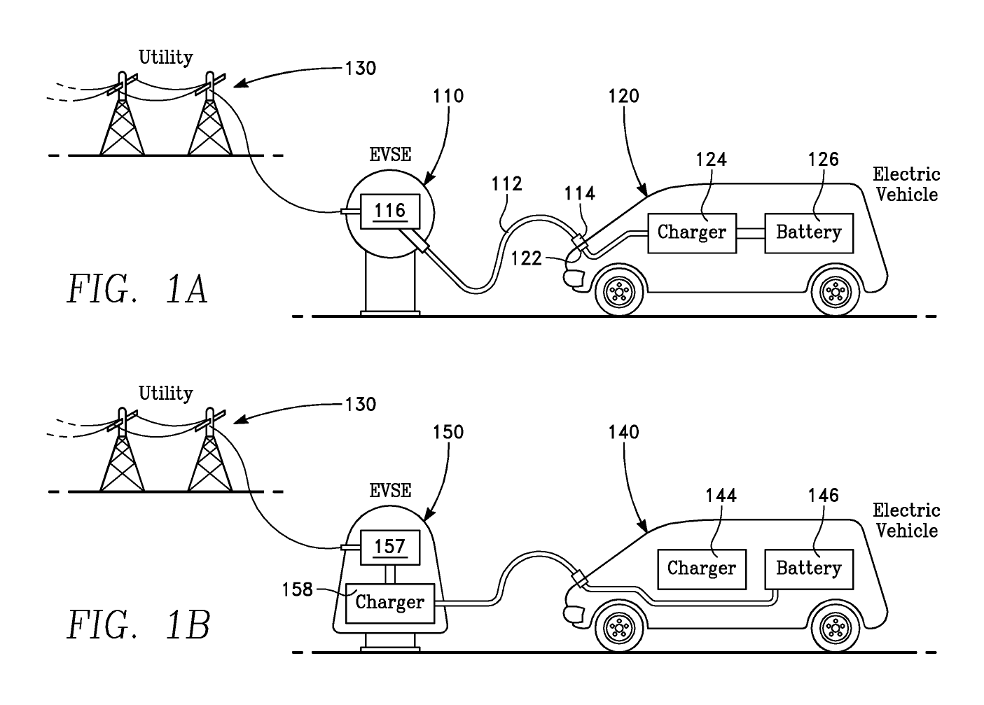

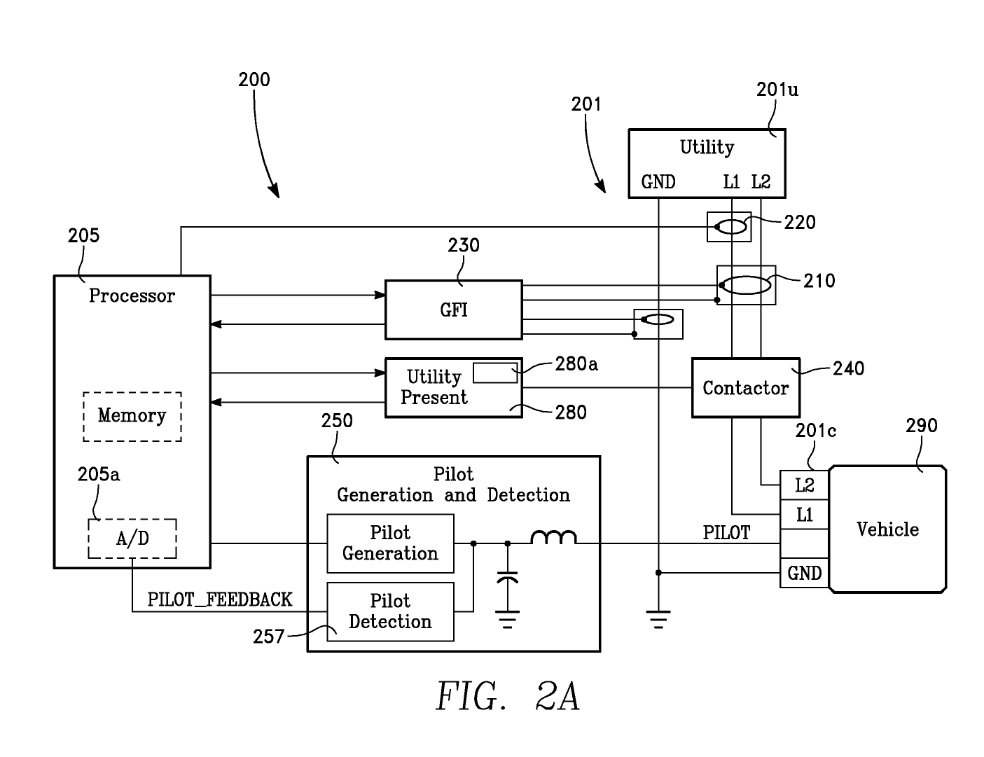

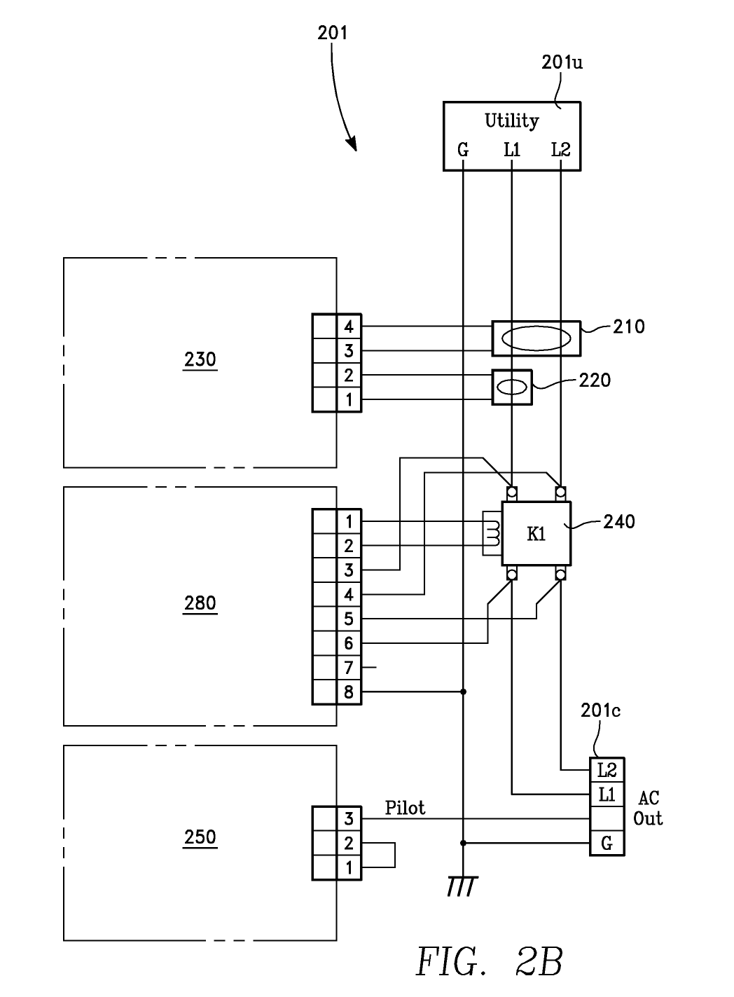

FIG. 1A shows an EVSE 110 attached to an electric vehicle 120 and to the utility grid 130. The EVSE 110 has a cable 112 and a connector 114 that allows the power to be provided to the vehicle 120 when an electrical contactor in the EVSE's circuitry 116 is closed to complete the circuit. The EVSE circuitry 116 can also include a microprocessor, memory, sensors and the like, such as that shown in FIGS. 2A and 2B and described herein. Returning to FIG. 1A, the connector 114 is received in vehicle at a port 122 that is connected to the vehicle's on-board charger 124. The charger 124 is in turn connected to the vehicle's battery pack 126.

An EVSE 110 can be a device that connects the electric vehicle 120, and more specifically the vehicle's on-board charger 124, to the grid AC power 130. Alternatively or in addition, as shown in FIG. 1B, an EVSE 150 can itself contain a charger 158 in addition to control circuitry 157, and as such be capable of providing an electric vehicle 140, or more specifically the battery pack 146 of the vehicle, DC power (bypassing an on-board charger 144). The EVSE 150 may also have control circuitry 157 which may include a microprocessor, memory, sensors and the like, such as that shown in FIGS. 2A and 2B and described herein.

An EVSE may perform various safety functions and keep the power to the cable turned off until it determines that the cable is connected to a vehicle and the vehicle is ready to draw power. In situations where the vehicle's on-board charger is utilized (EVSE supplying AC power), typically the charger on the vehicle has the primary control over the charging current it draws from the grid. The EVSE can signal the vehicle charger how much power or current the vehicle is allowed to draw (it should be noted that the current SAE J1772™ standard allows only for the EVSE to prescribe the maximum current, independent of voltage. Later, if digital communications is used, a prescribed maximum power limit may be possible. However, since once connected the voltage stays pretty much constant during a single charging session, the current is a good proxy for power). Prescribing the maximum current may be accomplished via a pulse-width modulated pilot signal where the power available is mapped to the pulse width (as is defined in the SAE J1772™ standard). Also, a wired or wireless digital communications means could be used between the EVSE and the vehicle to accomplish the same task of indicating to the vehicle how much power is available to draw. This digital connection could provide charging current or power commands to the vehicle. The EVSE signal of the maximum current available has conventionally been based on the capacity of the EVSE and/or the power circuit it is connected to.

FIG. 2A shows a simplified block diagram of an electric vehicle supply equipment 200 or EVSE, which may include a pilot signal sampler, which in some embodiments may include the pilot signal detector 257 and the A/D converter 205a. FIG. 2B shows a schematic view of a cable 201 to connect utility power to an electric vehicle (not shown in FIG. 2B) along with some associated circuitry. In the embodiment of FIG. 2B, the EVSE 200 contains L1 and L2 and ground G lines. The cable 201 connects to utility power at one end 201u and to an electric vehicle (not shown) at the other end 201c. The EVSE 200 contains current transformers 210 and 220. The current transformer 210 is connected to a ground fault interrupt or GFI circuit 230 which is configured to detect a differential current in the lines L1 and L2 and indicate when a ground fault is detected. Contactor 240 may be open circuited in response to a detected ground fault to interrupt utility power from flowing on lines L1 and L2 to the vehicle (not shown in FIG. 2B). Determining the grid frequency in some embodiments can be performed by the EVSE's processor 205 via the operational software, as such, an existing EVSE may be upgraded to have such a functionality without any hardware changes, only the firmware.

Referring to FIGS. 2A-2B, the electric vehicle supply equipment 200 has a utility power L1, L2 input and an output 201c to an electric vehicle. A frequency detector 280a may be located in the utility present circuitry 280. The processor 205 (which may be a microcontroller) may be programmed to determine a frequency error based on the output from the frequency detector and to determine a charging rate parameter, i.e. charging current or charging power, based on the frequency error (or more generally, a function of frequency error). A circuit, such as pilot circuitry 250, provides the charging rate parameter to an electric vehicle 290, in response to commands from the processor 205, so as to control the charging rate of the electric vehicle 290 in response to the frequency error.

In various embodiments, the frequency detector 280a may include a zero crossing detector which has a comparator connected to sense the utility power input. The comparator outputs a square wave binary output. The processor 205 may be programmed to determine the frequency of a utility power input by counting a number of processor clock cycles between outputs of the zero crossing detector.

Embodiments of the present invention include an EVSE that in response to the grid frequency, or to changes thereto (e.g. frequency error from a target frequency, or to the rate of change of frequency, or to some combination of these two), changes or adjusts the signal to the vehicle indicating how much current or power is available for the vehicle, and/or it's on-board charger to draw. That is, a power or current value less than the EVSE's maximum design power or current, is dynamically varied in response to the frequency, or the rate of change in frequency (or any other function of frequency), to influence vehicle charging rate in a way that is beneficial to the grid.

In embodiments of the present invention, the EVSE senses the grid frequency and/or the rate of change in grid frequency, via any of a variety of means, including as set forth herein and known techniques, and then determines a corresponding setting of, or change to, the amount of power or current available signaled to the vehicle.

Because different vehicles that may use the EVSE may have varying maximum and minimum charging capabilities (which may be due to limitations such as the size of the on-board charger as well as the vehicle's predefined minimum charging current), the EVSE may determine the minimum and maximum charge current for the connected vehicle. This determination typically occurs at the start of charging event to define a usable current range of charging. The minimum charging current will usually be the same for all vehicles that use the SAE J1772 protocol, at 6 amps. If a vehicle was configured to have a 10 amp minimum charge current, the vehicle would have to stop charging entirely if the EVSE indicated that less than 10 amps was available.

In addition to the EVSE self-calibration feature as referenced above, the EVSE may also include a re-calibration, where after the start of the charging and the EVSE first defines the min-max range, it then updates the range periodically during the charge. Namely, during charging, in the event the EVSE senses that at some point the vehicle does not draw as much current as it had been allowed to via the pilot duty cycle, then the EVSE would adjust or reset the maximum charging current to the actual amount observed or some other appropriate amount. Such a reduction in the amount that the vehicle draws may be a result of the vehicle nearing the end of its charging cycle (e.g. it's battery is nearing being full), or that the temperature of the battery has caused a reduction in the charging rate.

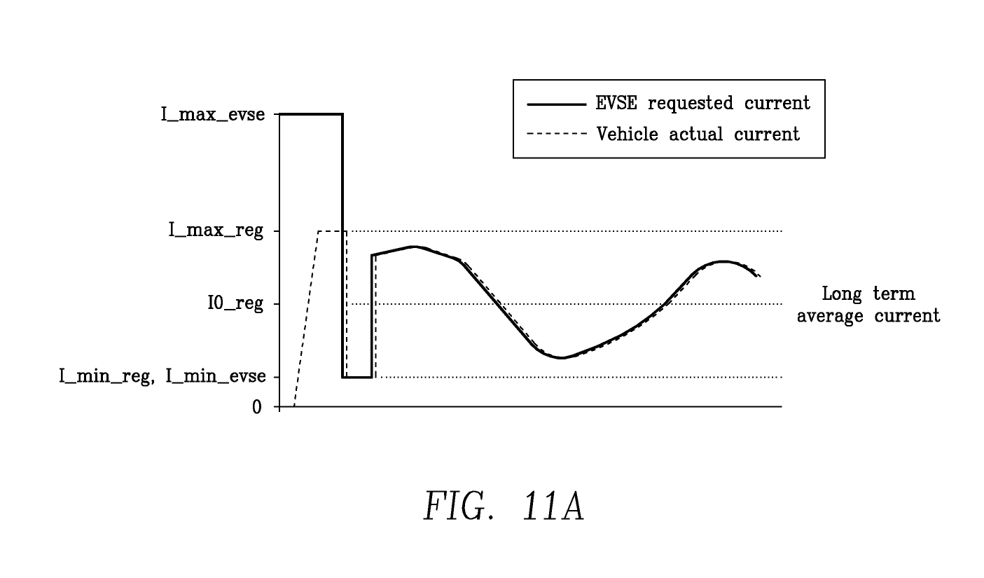

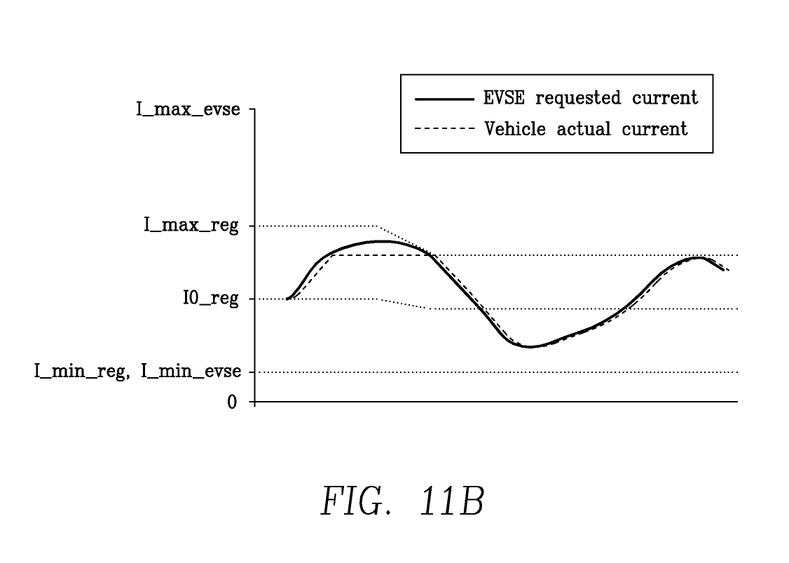

FIGS. 11A and 11B show autocalibration at start and autocalibration during charging, respectively, in accordance with at least one embodiment of the present invention.

In embodiments, the frequency regulation capacity available by the EVSE can be set between zero (ie no regulation) and a maximum dictated by the minimum of any of:

(a) the vehicle charger maximum current less the vehicle charger minimum charging current;

(b) the vehicle charger maximum current less the EVSE minimum current command available through the pilot signal;

(c) the EVSE maximum current available less the vehicle charger minimum current; or

(d) the EVSE maximum current available less the EVSE minimum current command available through pilot signal.

The units of regulation capacity are power, and are based on the power deviation available between the average of the maximum and minimum charge current and the actual maximum or minimum charge current.

Regulation capacity=[(I_max_reg+I_min_reg)/2−I_min_reg]*Vrms

Or, simplified:

(I_max_reg−I_min_reg)*Vrms/2

(The example showed here is applicable to single-phase power. Suitable adjustments can be made for the case of three-phase power). It should be noted that while in embodiments, a range could be defined that is less than the vehicle's or the EVSE's maximum and minimum charging current, using the greatest overall range will in turn provide the greatest grid frequency regulation and ultimate benefit to the grid. The range could be set dynamically based on how fast the driver or utility wants the vehicle to charge. For example, if a faster charge rate is desired, the minimum charging current can be set above the minimum of the vehicle or EVSE, raising the average charging current (and reducing the regulation capacity). Similarly, if a slower charging rate were desired, the maximum charging current could be set below that of the EVSE or vehicle, resulting in lower average charge current and reduced regulation capacity.

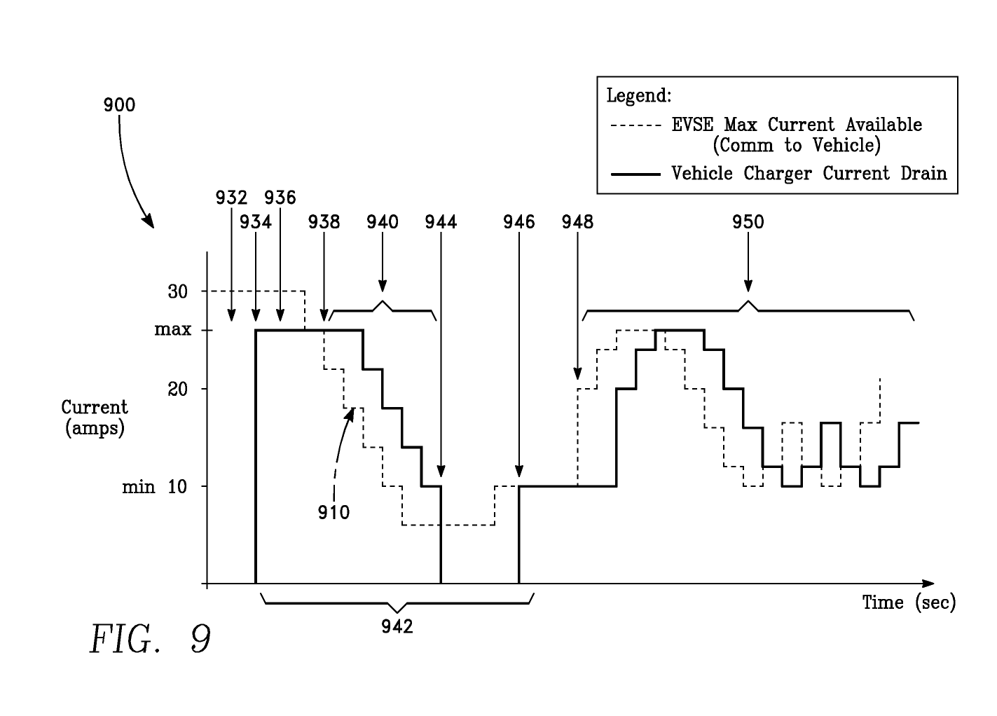

An example of an embodiment of the EVSE's charging current range determination and the self-calibration 942 is set forth herein and shown in the graph 900 of FIG. 9, with an EVSE that has a maximum available current of 30 amps. The dashed line represents the EVSE communication to the vehicle and the solid line represents the vehicle charger current draw. The example of FIG. 9 is provided for illustration purposes. As can be appreciated by one skilled in the art, other algorithms may be used to find the vehicle maximum and minimum charging current or other parameter.

Referring to FIG. 9, upon the electric vehicle being connected to the EVSE at 932, the EVSE will via the pilot signal inform the vehicle that it can draw to the maximum of 30 amps, namely the EVSE maximum current available. Then the vehicle's charger will begin its charging at 934, at a current at or less than the 30 amps value (even if the vehicle is capable of drawing more than the 30 amps it will limit to the maximum that the EVSE has communicated to the vehicle. The EVSE will then measure the amount of current that the vehicle is drawing in response to the EVSE's initial maximum current available and identify this measured amount to be the vehicle's charger maximum current at 936. Then, in order to define the current range available the EVSE will seek the vehicle charger minimum current, beginning at 938, by progressively reducing at 910 the EVSE maximum current available, reported to the vehicle over the pilot signal, and measuring the resulting vehicle response 940 (the amount of current that the vehicle is drawing) to determine the lowest value prior to the vehicle terminating charging at 944, namely the vehicle charger minimum current (shown as 10 amps in FIG. 9). The EVSE requests the vehicle minimum current, and then measures the vehicle minimum current at 946. In may cases, the vehicle charger will operate down to a minimum value of 6 Amps which corresponds to the minimum current value that can be encoded on the pilot signal according to the SAE J1772™ standard. The vehicle charger current range is then determined as the difference between the vehicle charger's maximum current and minimum current. Defining the vehicle charger current range allows the EVSE to perform frequency-responsive charging. During the charging of the vehicle, the EVSE will continue monitoring the amount of current that the vehicle is drawing in response to the EVSE maximum current available reported to the vehicle during the frequency-responsive charging at 950, which begins at 948. If the EVSE measures a difference then it may automatically redefine either the maximum or minimum values. It should be noted that the minimum value of the range may also be defined by the EVSE itself or due to a user preference (e.g. minimum charging time). It should be noted that in FIG. 9 that the graph is not to necessarily to scale, especially to the time parameter. The response of the vehicle to the EVSE command current is shown as much greater to aid in visualization. Also it should be noted that the initial ramp up of the vehicle's charger current draw is shown as being very steep, where in actual applications it would ramp up much more slowly while the EVSE monitored it to determine the max current draw.

The EVSE may determine the allowable charging current, or possibly power if digital communications between the EVSE and vehicle are present, based on locally-sensed frequency, and/or other parameters that are communicated to the EVSE from an external source. The frequency-based current command to the vehicle can be based on many different methods including any function, including but not limited to consideration of the frequency, grid scheduled target frequency (usually 60 Hz), frequency error (measured frequency−target frequency), time integral of the grid frequency error, time derivative of the grid frequency error. (In some embodiments, the target frequency is considered by the EVSE to have fixed value. For example, the target value may be fixed at the typical value, i.e. 60 Hz for the United States. In other embodiments, the target frequency can be a variable value received from a grid operator or other external source, which may sometimes be more, or less, than the typical value for the particular region or country.

Below are some example EVSE Parameters and Equations:

Initial Values:

a. freq_grid_threshold=−50 mHz

b. freq_deriv_grid_threshold=−25 mHz/s

Parameters:

| | |
|---|---|
| freq_target: Setpoint for frequency. | (mHz) |
| freq_gain: fraction of Ireg_cap per freq error | (1/mHz) |
| freq_deriv_gain: fraction of Ireg_cap per freq_deriv | (1/mHz/s) |
| I_max_reg: Maximum charging current | (A) |
| I_min_reg: Minimum charging current | (A) |
| freq_grid_threshold: freq_error excursion | (mHz) |
| threshold to disable EVSE | |
| freq_deriv_grid_threshold: grid freq change | |
| threshold to disable EVSE (mHz/s) | |

Equations:

| | |
|---|---|
| freq_error = freq-freq_target | (mHz) |
| freq_deriv: time derivative of frequency | (mHz/s) |

Sign Convention:

Positive freq_error=>Increase current

Positive freq_deriv=>Increase current

I0_reg=(I_max_reg+I_min_reg)/2

I_reg_cap=(I_max_reg−I_min_reg)/2

Icmd=I0_reg+freq_gain*freq_error*I_reg_cap+freq_deriv_gain*freq_deriv*I_reg_cap

Limit Icmd to: I_max_reg>Icmd>I_min_reg

I_max_reg<I_max_evse (30 A)

I_min_reg>I_min_evse (6 A)

In case where I_min_reg>I_max_reg, set Icmd to I_max_reg

Special Case:

Shut off current in response to grid frequency stress when either:
Icmd=0 (stop pilot oscillation & open contactor) if freq<freq_grid_fault
Icmd=0 (stop pilot oscillation & open contactor) if freq_deriv<freq_deriv_grid_fault

After fault condition clears (indicated by frequency recovery back to the target value or some other value), wait a random time (for example 10 seconds plus a random number of seconds between 1 and 60) before re-enabling pilot oscillation and closing contactor.

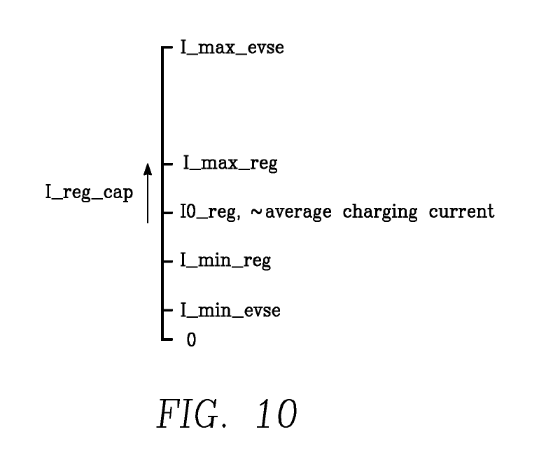

FIG. 10 shows definitions of charge current values in accordance with at least one embodiment of the present invention. FIG. 10 illustrates the relationship of the charge current values corresponding with the Equations presented in the above paragraph.

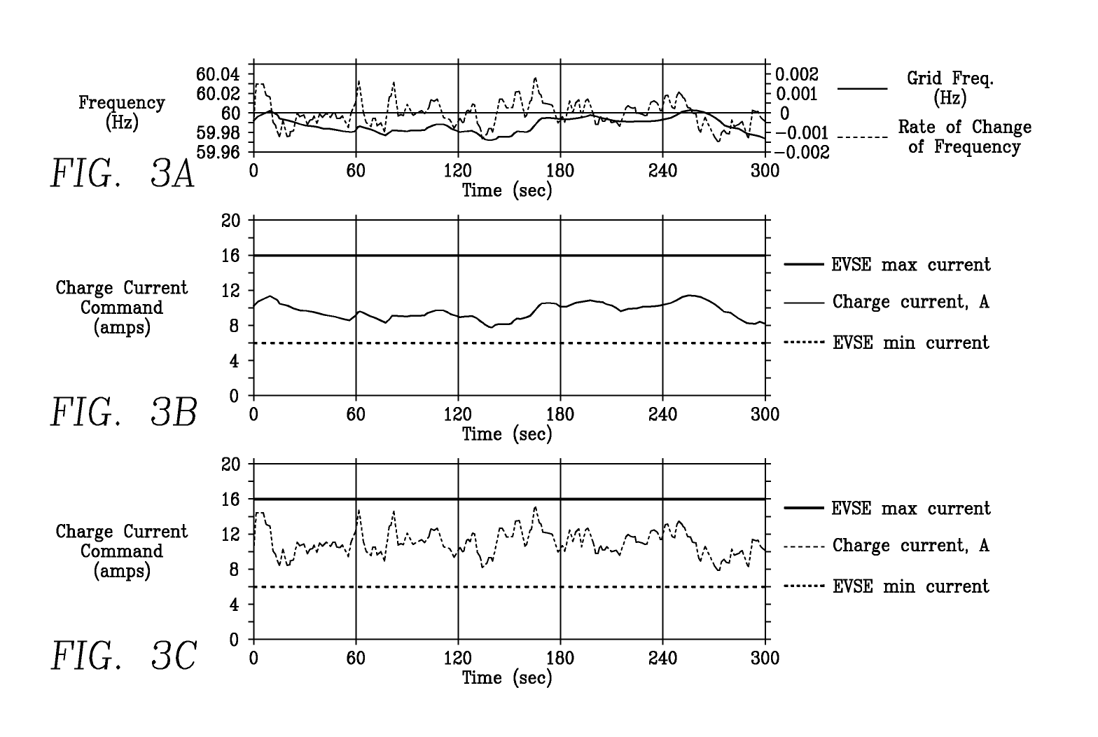

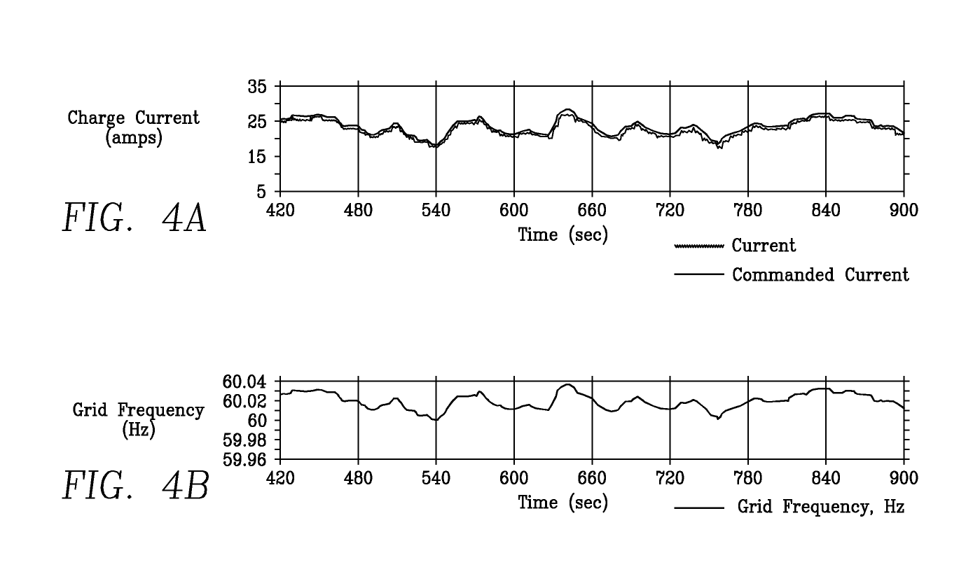

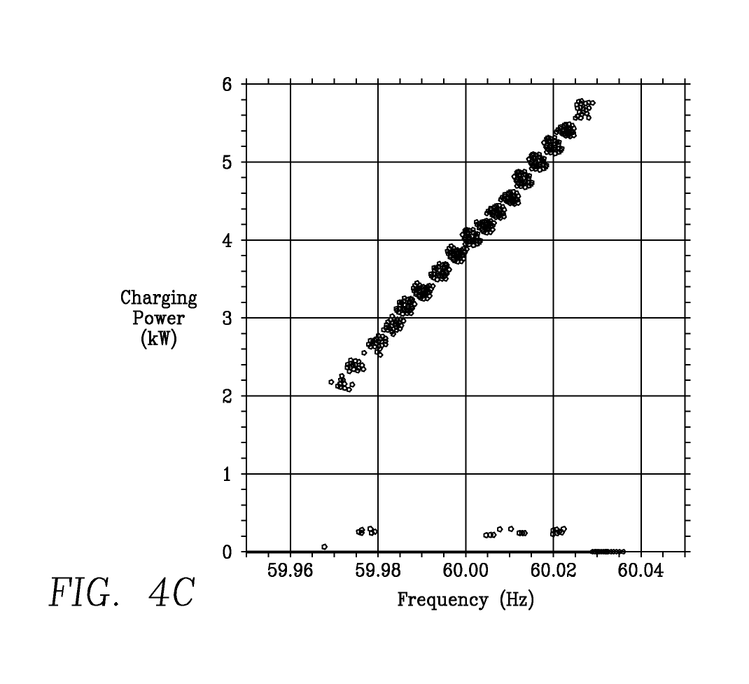

FIGS. 3A-C show example graphs of the sensed frequency (FIG. 3A), calculated rate of change of frequency (FIG. 3A), vehicle commanded current either in proportion to frequency error (FIG. 3B) or rate of change of frequency (FIG. 3C). FIGS. 4A and 4B show example vehicle responses to the charge current commanded by the EVSE (in this case the commanded current is proportional to the frequency error). FIG. 4C is a graph of an example vehicle response showing the relationship of vehicle charging power versus sensed grid frequency which is evident in FIGS. 3A-4B. As the sensed grid frequency increases above 60 Hz, the charging power increases generally linearly in response, in a quasi-step function. Similarly, as the sensed grid frequency decreases below 60 Hz, the target frequency, the charging power decreases generally linearly in response, in a quasi-step function. The quasi-step function results in this example are due to the characteristic of the on board vehicle charger which controls charging current in discrete increments.

The EVSE may communicate the calculated allowable charging current or power to the vehicle over the pilot signal, and/or digitally if that capability is present. Specifically, communication of the commanded current from the EVSE and the vehicle can be through pilot signal pulse width, or through digital power line carrier methods over the power lines in the cable or the pilot wire in the cable, as well as via other hardwire or wireless connections. A vehicle should respond to the new command relatively quickly, generally within about 2 seconds. Overall performance metrics such as regulation capacity, or a quality metric such as rms error from command, can be communicated to an external entity for monitoring and verification/payment.

The EVSE can measure frequency by counting the number of processor clock cycles between zero crossings of the sensed line voltage, producing a cycle time sixty times per second on average. The corresponding frequency values can readily be calculated from the cycle times. These frequency values can be filtered with a digital filter in order to provide a smoother less noisy signal. An example of a digital filter is shown below:

$$H ( s ) = \frac{1}{τ s + 1}$$

Bilinear Transform:

$$\begin{matrix}\begin{matrix}δ = \frac{1}{T} ln ( z ) \\ = \frac{2}{T} [ \frac{z - 1}{z + 1} + \frac{1}{3} {( \frac{z - 1}{z + 1} )}^{3} + \frac{1}{5} {( \frac{z - 1}{z + 1} )}^{5} + \frac{1}{7} {( \frac{z - 1}{z + 1} )}^{7} + … ] \\ \approx \frac{2}{T} \frac{z - 1}{z + 1} \\ = \frac{2}{T} \frac{1 - {z}^{- 1}}{1 + {z}^{- 1}}\end{matrix} & \\ y ( n ) = \frac{T}{T + 2 τ} ( x ( n ) + x ( n - 1 ) ) - \frac{T - 2 τ}{T + 2 τ} y ( n - 1 ) & \end{matrix}$$

Example Values:

Tau=2, T= 1/60 for frequency filter

The time rate of change of frequency can be calculated using numerical methods that provide filtering. Ref: http://www.holoborodko.com/pavel/numerical-methods/numerical-derivative/smooth-low-noise-differentiators/

It should be noted that while certain focus has been provided to use of an EVSE that commands a charger on-board the vehicle, that embodiments of the present invention also include an EVSE where the charger is off-board the vehicle and may be within the EVSE or otherwise controlled by the EVSE. With the charger on the EVSE, the EVSE would still sense the grid frequency and perform the same frequency-responsive charging. In addition, the off-board charger could provide unidirectional or bidirectional power to facilitate the frequency response.

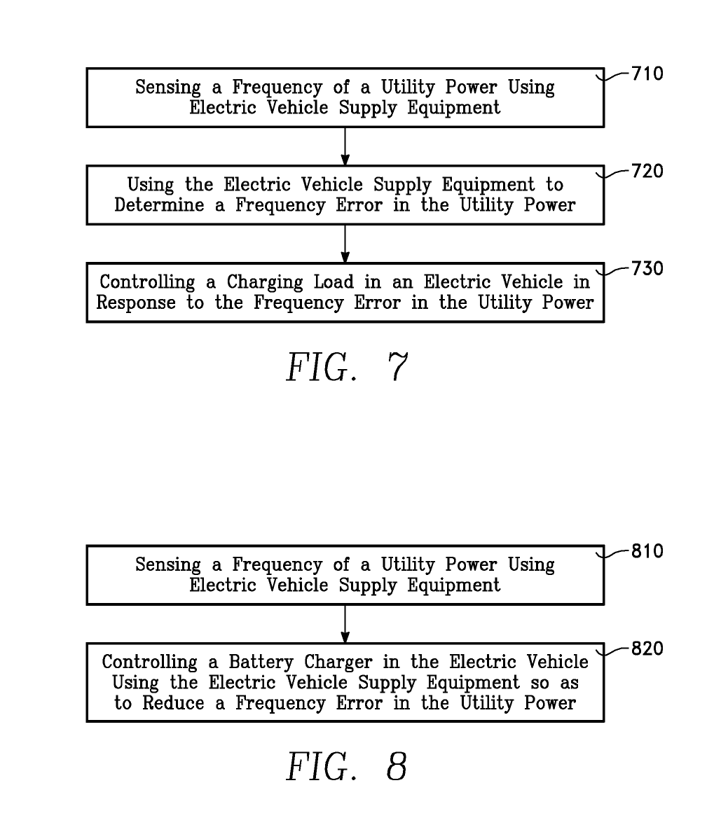

FIG. 7 is a flow chart of a method including the steps 710, 720, and 730 of sensing a frequency of a utility power using an electric vehicle supply equipment 710; using the electric vehicle supply equipment to determine a frequency error in the utility power 720; and controlling a charging load in an electric vehicle in response to the frequency error in the utility power 730.

FIG. 8 is a flow chart of a method including the steps 810 and 820 of sensing a frequency of a utility power using an electric vehicle supply equipment 810; and controlling a battery charger in the electric vehicle using the electric vehicle supply equipment so as to reduce a frequency error in the utility power 820.

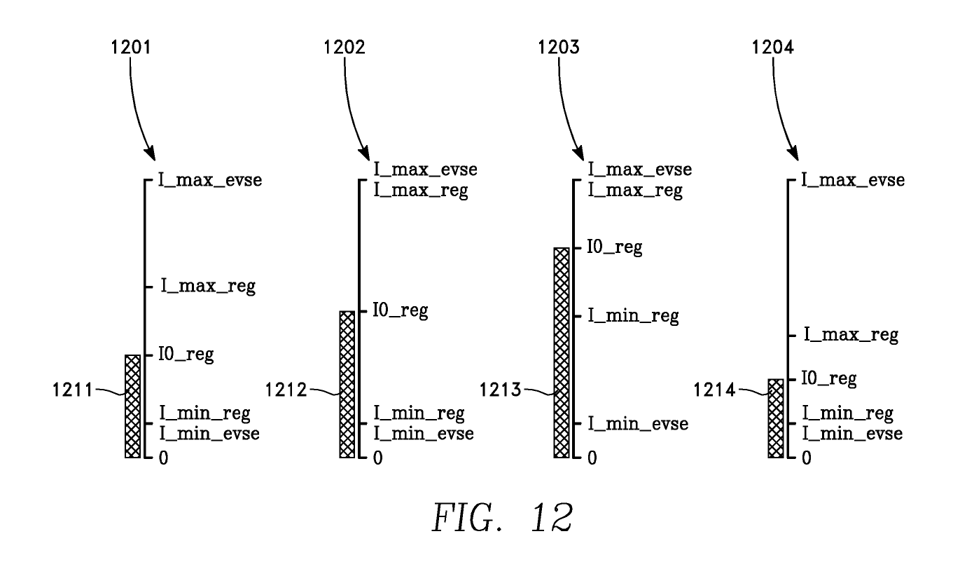

FIG. 12 shows examples of cases for charging in accordance with at least one embodiment of the present invention. Case 1201 is when the vehicle charger is smaller than the EVSE rating. Case 1202 is when the vehicle charger is equal to or greater than the EVSE rating. Case 1203 is like case 1202 but with I_min_reg increased for faster charging. Case 1204 is similar to case 1202 but with I_max_reg reduced for slower charging. The bars 1211, 1212, 1213, and 1214 show the average charging rate I0_reg.

### Grid-Fault Response

In embodiments, the EVSE may also provide a grid-fault response function. If the sensed frequency goes below a threshold value, or if the rate of change of frequency (in the negative direction) exceeds a threshold value, the EVSE will open its contactor, immediately halting power flow to the vehicle. This can be accomplished generally within 1 second of the beginning of the grid fault. The trigger frequency values (threshold value or rate of change) could be predefined or static (e.g. hard-wired, look-up table, etc.) in the system or they could be dynamic by being received and/or updated from an external source.

The grid fault recovery generally takes from tens of seconds to minutes to recover back to the nominal grid frequency. During this recovery period the EVSE contactor remains open and the EVSE monitors the frequency. Charging resumes after some pre-defined condition is met: could include, wait for some time (fixed amount plus random amount), wait until frequency recovers to specified value then wait random amount of time (between zero and specified number of seconds). For example, after the EVSE senses that the grid frequency reached a defined target, the EVSE starts a timer that waits for a random amount of time between minimum and maximum limits. When the time has passed, the EVSE closes the contactor and charging resumes as it had been just prior to the grid fault.

Other embodiments may have the resumption of charging wait until the target frequency is again reached, then immediately turn on charging at the minimum rate, and from there ramp up the regulation capacity to the maximum rate over some time period, could be fixed time period, or could be based on the elapsed time between the initial event and the time at which the target frequency was recovered.

Examples of grid fault responses are shown in FIGS. 5, 6A, and 6B. FIG. 5 shows frequency excursion where point A indicates the start of the event where the frequency drops down to point C and then begins to recover towards point B. FIGS. 6A and 6B show an example load drop 620 on a sensed grid fault at 610. Where FIG. 6A shows the grid frequency drop 610 from the target frequency (60 Hz in this example) and then slowly returns thereto at 630. FIG. 6B shows charge current command to zero at 620 in response to the grid fault at 610. The charging command is set to zero at T+4 seconds based on the sensed large rate of change of the frequency at 610. As noted in FIG. 6B the current goes to zero at 624 by opening the contactors of the EVSE, which stops current flow sooner (up to several seconds) than if the vehicle charger were interpreting the pilot signal. Charging current is then kept at zero while the frequency recovers to the target value (60 Hz) at 630, and from that point for a randomly selected additional time 640 between zero and some defined upper limit. The upper limit could for example be a fixed number, or it could be the time between the initial fault and recovery of the frequency to 60 Hz (about 333 seconds in this example). A random delay can be used before charging is resumed.

### Hybrid Grid Frequency Regulation

Grid regulation is based on regulating at quantity called area control error, or ACE, to a target value of zero. ACE generally includes a combination of two terms: the grid frequency error, and the interchange error. The interchange error is the difference between scheduled interchange with neighboring control areas and the actual interchange.

In embodiments of the present invention, the interchange error term may be received by the EVSE through any form of communication (network, internet, wireless, broadcast such as RDS, a low-rate digital broadcast system that is sent out by FM radio stations, etc.) and can be used with, or added to, the locally sensed grid frequency values to determine the current or power command to the charger.

To do this the EVSE would receive external power commands based on interchange error. These external commands would be summed with the local frequency responsive power calculation to get the overall power command for the load. Typically, the interchange error term is more slowly-varying than the frequency term, so the interchange error term could be sent to the vehicle at a slower update rate.

The interchange error term sent out to EVSEs through one of the methods described above could be either customized for each EVSE and/or vehicle, or to reduce complexity and unique data communications, it could be a normalized value that is the same for all EVSEs or the same for groups of EVSEs.

A frequency regulation resource can be any of: generation, storage, or load. Generation provides regulation by varying the power generation amount up and down between upper and lower limits of generation; the storage resource provides regulation by providing power to the grid or taking power from the grid, usually in a nearly symmetrical amounts (e.g. plus or minus 10 MW), and load does it all by varying load between upper and lower limits (as is the case with the current invention). The hybrid general case method is to communicate an interchange error term periodically to the regulation resource, which is added to a much more frequently calculated power value calculated based on locally-measured grid frequency.

The target or scheduled grid frequency could also be communicated (broadcast) to EVSEs performing frequency based regulation (e.g. a simple one-time communication such as 59.99 hz from hours 0:00 to 2:00). The target grid frequency is sometimes set at other than 60.000 Hz for purposes of adjusting the total number of daily AC cycles in order to maintain accurate timekeeping for certain clocks and other devices.

### User/Third Party Operational Control

In embodiments of the present invention, the user or some third party is allowed to have a limited or total control over the grid frequency responsive charging and/or the grid fault response function of the EVSE.

Because the frequency responsive charging must have a range of commandable currents or power levels, the EVSE can not charge the electric vehicle at or near the maximum charging capability of the EVSE while providing the frequency-responsive charging function. Therefore the overall duration of the charging of the vehicle can be significantly extended by the operation of the frequency responsive charging.

In many situations, such as overnight residential charging, the time available to charge the vehicle may be more than sufficient such that there is no real issue for the vehicle operator. However, in other cases where time available for charging is limited, the user may need to turn off the frequency-responsive charging. In embodiments, this may be a user operable button on the EVSE or a software setting on in the operating system of the EVSE (e.g. a remote setting by the user). In addition the user may be able to select the degree to which the frequency responsive charging may be utilized during charging, such as on a sliding scale (e.g. 0-100%), or alternatively the user might set a charging completion time. With a set charging completion time, the EVSE would given the actual (requiring sufficient communication between the EVSE and vehicle) or estimated level of charge of the vehicle, scale the minimum charge power level up to a higher value, such that the resulting average charging power would result in the vehicle becoming charged by the time specified. This would of course reduced the amount of frequency-responsive charging the EVSE was providing. In the limiting case when the vehicle is desired to be full at a time at or before that which would be possible if charging at the maximum rate allowed by either the vehicle or EVSE maximum limits. In this case the minimum charge power level would be set equal to the maximum charge power level, resulting in the vehicle charging at full rate while providing no frequency responsive charging.

Given the benefits of frequency responsive charging to the operation of the grid, the user may be offered an incentive (such as reduced electricity price) to turn on the responsive charging. Instead of the user controlling the use of the frequency responsive charging, a third party, such as the utility or service provider might have such control in exchange for incentives provided to the user. Such control might include reducing the upper maximum charging power limit at times when the overall supply of electricity generation is nearing limits.

What is claimed is:

1. A method for frequency responsive charging an electric vehicle comprising:
a) sensing a grid frequency of a utility power using an electric vehicle supply equipment; and
b) controlling a charging load in an electric vehicle in response to a function of the sensed grid frequency.

2. The method of claim 1 comprising using the sensed frequency to vary the charging load of the electric vehicle proportional to at least one of: (a) a grid frequency error; (b) a derivative of the grid frequency error; (c) an integral of a grid frequency error; (d) an other function of the sensed grid frequency; or (e) combinations thereof.

3. The method of claim 2, wherein controlling the charging load comprises controlling a vehicle charger using at least one of: (a) a hard wire signal; (b) a wireless signal; or (c) a power line signal.

4. The method of claim 3, wherein controlling the charging load comprises controlling the vehicle charger using a pulse width modulated pilot signal.

5. The method of claim 1, wherein controlling a charging load in the electric vehicle comprises using a pulse width modulation pilot signal.

6. The method of claim 1, wherein controlling the charging load in the electric vehicle comprises controlling the charging load in response to a grid frequency error in the utility power.

7. The method of claim 6 comprising:
a) using the electric vehicle supply equipment to determine the grid frequency error; and
b) controlling the charging load in the electric vehicle in response to the grid frequency error.

8. The method of claim 1, wherein controlling the charging load in the electric vehicle comprises using the electric vehicle supply equipment to command an electric vehicle charger in the electric vehicle.

9. The method of claim 1, wherein controlling the charging load in the electric vehicle comprises controlling an electric vehicle charger in the electric vehicle supply equipment.

10. The method of claim 1, wherein controlling the charging load comprises selecting a range of regulated current draw for the charger that is within a range of allowable current draw for the electric vehicle.

11. The method of claim 1, wherein controlling the charging load comprises controlling a range of a current draw by the charger so as to compensate for grid frequency error at frequency values that are within the utility power deadband range centered about a target frequency.

12. A method for regulating area control error in utility power, the method comprising:
a) sensing a grid frequency of a utility power using an electric vehicle supply equipment; and
b) controlling a charging load in an electric vehicle in response to a combination of a function of the sensed grid frequency and a function of an externally supplied value.

13. The method of claim 12, wherein controlling comprises controlling in response to both the function of the sensed frequency and an externally supplied interchange error.

14. The method of claim 13, wherein controlling the charging load in the electric vehicle comprises varying a frequency-dependent portion of the vehicle charging load to be proportional to at least one of: (a) a grid frequency error; (b) a derivative of the grid frequency error; (c) an integral of a grid frequency error; (d) an other function of the sensed grid frequency; or (d) combinations thereof.

15. The method of claim 13, wherein the controlling in response to the function of the sensed grid frequency comprises controlling in response to a grid frequency error.

16. The method of claim 12, wherein the controlling in response to the function of the sensed grid frequency comprises controlling in response to a grid frequency error.

17. A method for charging an electric vehicle comprising:
a) sensing a frequency of a utility power using an electric vehicle supply equipment external to the electric vehicle; and
b) controlling a battery charger in the electric vehicle using the electric vehicle supply equipment so as to reduce a frequency error in the utility power.

18. The method of claim 17, wherein controlling comprises using at least one of:
(a) a frequency error of the utility power; (b) a derivative of the frequency error; or (c) an integral of the frequency error to adjust a charging load applied by the battery charger.

19. A method for supplying a synthetic inertia to the power grid comprising controlling a battery charger connected to a utility power grid using a derivative of a frequency error to adjust the charging load applied by the battery charger so as to reduce a rate of change of the frequency error in the utility power grid.

20. The method of claim 19, wherein controlling the battery charger comprises controlling so as to compensate for an actual power imbalance on the utility power grid.

21. The method of claim 19, wherein controlling a charging load in an electric vehicle comprises controlling a charger in the electric vehicle.

22. The method of claim 19, wherein controlling a charging load in an electric vehicle comprises controlling a charger in an electric vehicle supply equipment.

23. A method for frequency responsive charging comprising:
a) sensing a frequency of a utility power using an electric vehicle supply equipment;
b) determining a regulated charging range by sensing a maximum charge rate parameter and a minimum charge rate parameter for a connected electric vehicle; and
c) adjusting a charge rate parameter within the regulated charging range to control a charging load in the electric vehicle in response to a function of the sensed grid frequency.

24. The method of claim 18, wherein determining a maximum charge rate parameter comprises at least one of: (a) determining a maximum charging current; or (b) determining a maximum charging power.

25. The method of claim 18, wherein adjusting the charge rate parameter comprises using the sensed frequency to vary the charging parameter to the electric vehicle in proportion to at least one of: (a) a grid frequency error; (b) a derivative of the grid frequency error; (c) an integral of a grid frequency error; (d) an other function of the sensed grid frequency; or (d) combinations thereof.

26. The method of claim 18, further comprising resetting at least one of: (a) a maximum charge rate parameter; or (b) a minimum charge rate parameter for the purpose of increasing or decreasing the average charging rate.

27. A system for compensating for frequency error in a utility power grid, the system comprising:
a) a utility power supply comprising frequency variations;
b) an electric vehicle comprising an onboard charger; and
c) an electric vehicle supply equipment comprising:
(i) a utility power input;
(ii) an electric vehicle supply output;
(iii) a frequency detector having an output;
(iv) a processor adapted to determine a frequency error based on the output from the frequency detector and to determine a charging rate parameter based on the frequency error; and
(v) a circuit adapted to command the charging rate parameter to an electric vehicle so as to control the charging rate of the electric vehicle in response to the frequency error.

28. The system of claim 27, wherein the

29. A system for compensating for frequency error in a utility power grid, the system comprising:
a) a utility power supply comprising frequency variations;
b) a plurality of electric vehicle supply equipment connected to the utility power supply;
c) a plurality of electric vehicle chargers for charging electric vehicles comprising an onboard charger; and
d) an electric vehicle supply equipment adapted to set the charging load in the electric vehicles so as to control the charging rate of the electric vehicle in response to the function of the frequency.
